(19) United States
(12) Patent Application Publication
(10) Pub. No.: US 2025/0254038 A1
(43) Pub. Date: Aug. 7, 2025

(54) SENSOR

(71) Applicant: KNORR-BREMSE Systeme für Nutzfahrzeuge GmbH, München (DE)

(72) Inventors: Christian Huber, München (DE); Amadeus Mlynarski, München (DE); Sagar Vitthal Shelke, München (DE)

(21) Appl. No.: 19/045,844

(22) Filed: Feb. 5, 2025

(30) Foreign Application Priority Data
Feb. 6, 2024 (DE) 102024103311.8

(51) Int. Cl. H04L 9/08; B62D 15/02; H04L 9/32; H04W 12/60

(52) U.S. Cl. CPC H04L 9/0894; B62D 15/0215; H04L 9/32; H04W 12/66

(57) ABSTRACT

A sensor for a vehicle, such as a commercial vehicle. The sensor includes a housing, a measurement interface configured to capture a measurement variable of the vehicle for generating a raw measurement data describing the measurement variable. The sensor includes a processing device which is configured to process the raw measurement data to generate a measurement data; a data interface in communication with the processing device and configured to exchange data between the sensor and other components; and a storage section configured to store at least one cryptographic key, wherein the processing device is configured to use the at least one cryptographic key to encrypt and/or decrypt and/or validate data sent or received via the data interface.

The present invention relates to a sensor for capturing a measurement variable of a vehicle. The invention also relates to a system, a vehicle and a method.

The progressive digitization of vehicles entails various advantages. Above all, safety functions such as electronic stability control or the implementation of closed-loop brake control means have thus become possible. In addition, it has been possible to simplify existing functions such as level control or oil level measurement. In order to also be able to update such functions in existing vehicles, for example in order to correct errors in the software or simply install a new software version, it is necessary to open the software and/or hardware architecture of the vehicle to the outside by means of appropriately designed interfaces, such that appropriate access is possible.

However, these interfaces and also data lines, which are not intended as interfaces, but for example allow access wirelessly or through subsequently soldered connections, also enable unauthorized access to the digital system of the vehicle or at least to subsystems thereof, such as the electronic stability control, the closed-loop brake control means or others of the functions mentioned above. Measures to increase the threshold against such unauthorized access shall be referred to below as “measures for increasing cyber security”, wherein “cyber security” as such describes the threshold against such unauthorized access.

Cyber security, or its increase, is already taken into account by legislation. For example, there are regulations for the security of vehicles against cyber attacks (e.g. UNECE R 155) and regulations that describe prerequisites for updating software in control units of vehicles (UNECE R 156). The latter regulation in particular refers to the provision of software update management systems (SUMS) by vehicle manufacturers. A SUMS is intended to ensure that an update of software functions that were relevant to type approval (e.g. exhaust gas, brakes, engine control) is developed and validated in such a way that said functions continue to operate in accordance with the law even after the update. UNECE R 156 also requires such updates to be “safe and secure” without further explanation. The term “safe” refers to the protection against malfunctions of the software itself (bugs). The term “secure” refers to the protection against tampering in the update process. For example, the update mechanism is intended to prevent the installation of malware and tuning software. Both constitute unauthorized access.

The object of the present invention is therefore to show measures for increasing cyber security, especially in the case of sensors.

This object is achieved by the subjects of the independent claims. The dependent claims relate to advantageous developments.

A sensor for a vehicle, in particular for a commercial vehicle, is disclosed. The sensor has the following elements:
a housing;
a measurement interface designed to capture a measurement variable of the vehicle and designed to generate raw measurement data describing the measurement variable;
a processing means which is designed to process the raw measurement data to form measurement data.

Preferably, the sensor further has the following elements:
a data interface which is designed to exchange data between the sensor and other transmitters or receivers and is connected to the processing means for this exchange of data;
a storage section which is designed to store at least one cryptographic key and to make it available exclusively to the processing means, wherein
the processing means is designed to use the at least one key to encrypt, decrypt or validate data sent or received via the data interface, wherein
the storage section is formed as or in a hardware security module.

The provision of the at least one key in a hardware security module provided as a storage section is associated with the advantage that the at least one key is thus protected against unauthorized access. Without a corresponding counterpart, the at least one key can prevent data such as measurement data, raw measurement data or software of the sensor from being read out or changed without authorization.

The hardware security module can be implemented in particular by an SHE (Secure Hardware Extension) or by the Evita light, medium or full standard.

The hardware security module makes it possible to implement encryption functions for exchanging data, in particular via the data interface of the sensor.

The storage section can be designed as a storage device structurally separated from the processing means. It can thus be placed relatively freely in the housing of the sensor.

Alternatively, provision may be made for the storage section and the processing means to be formed as a structural unit. This provides a complete module that facilitates installation in the sensor housing. The processing means may be formed at least partially, preferably completely, as part of the hardware security module. This protects essential functions of the sensor which are realized with the processing means.

Preferably, the data received via the data interface are application data or program code or they contain application data or program code. This makes it possible to update the sensor. The processing means is preferably designed to validate data received via the data interface. For this purpose, the data preferably contain a cryptographic key, a hash value or a cryptographic signature. These can be compared with a cryptographic key stored in the storage section, a hash value, or with a cryptographic signature by the processing means. If the comparison reveals that the key, the hash value or the cryptographic signature, of the data, is expected by the processing means, the processing means evaluates the received data as correct and trustworthy and initiates a corresponding action, such as an import or transfer of the application data or an update of the software of the sensor.

Preferably, the data sent via the data interface are the measurement data or status information relating to the sensor or they contain the measurement data or the status information. In this case, the sensor, preferably the processing means, is designed to provide the sent data with a cryptographic key, a hash value or a cryptographic signature from the hardware security module, in particular from the storage section, so that other receivers can in turn carry out a corresponding comparison of the keys in order to ensure that the sensor can be trusted as a data source and that the data sent are correct.

This can be implemented as part of secure onboard communication (SecOC), with the result that the sensor can securely communicate with further receivers.

Preferably, the at least one key is linked to an identification mark of the sensor and/or to a manufacturer-specific identification mark and/or to a customer-specific identification mark. In this way, a correspondingly designed system, as is described, for example, further below, in which the sensor is installed, can check whether the sensor is a sensor desired or intended for the system. This allows for the detection of improper copies or unapproved designs of the sensor. Provision may then also be made for a system to not continue to use the sensor. Further measures that are possible for a corresponding system are explained further below.

The check as to whether the sensor is a sensor desired or intended for the system can alternatively or additionally also be carried out as part of a method for checking the permissibility of a combination of such a system for a vehicle with such a sensor. For example, such a method is explained further below. This makes it possible to carry out an appropriate check even during or before the sensor and the system are assembled.

The check can therefore be carried out even at an early stage of the manufacturing process, for example at a supplier company that manufactures or assembles the combination of system and sensor. For this purpose, for example, a customer, such as a vehicle manufacturer, or a supplier, can provide the supplier with the necessary keys and further information.

Preferably, the identification mark of the sensor is a part and/or serial number and/or a vehicle identification number and/or an ECU ID and/or a manufacturer name. These are clearly assigned to the sensors by manufacturers during the production of the sensors or later as part of vehicle manufacture or assembly. This makes it possible to identify an approved sensor using these numbers or it is also possible to detect an unapproved sensor using errors in these numbers. In particular, it is possible to assign a sensor to a specific vehicle or to a specific system, such as a closed-loop brake or driving dynamics control system.

Preferably, the storage section is designed to store program parts of the processing means and/or the raw measurement data and/or the measurement data, which have been authorized by means of the at least one key, in the storage section. In this way, such information can be protected and cannot be used without the corresponding cryptographic key. This prevents unauthorized access.

Preferably, the sensor, in particular the processing means, is designed to check data, which in turn are provided with a cryptographic key and are received via the interface, or communication, which is directed to the sensor and is received via the interface, for the trustworthiness of its/their transmitter. Preferably, the sensor, in particular the processing means, is further designed to output a message via the interface or to deactivate itself or a system in which the sensor is provided, or to put itself into a secure state, if the transmission source or the received data or the communication directed to the sensor has/have been classified as untrustworthy. This can prevent unwanted application data or unwanted program code from being used by the sensor, in particular by the processing means.

Possible ways of protecting the sensor structurally against unwanted or unauthorized access from the outside, in particular against unwanted wireless access from the outside, are described below. This can be effected in combination with or independently of the above-described embodiments of the sensor. The following sensor should be understood as a common element of both the sensors described above and the sensors described below and has already been described in the introduction above:

A sensor for a vehicle is disclosed. The sensor has the following elements:
a housing;
a measurement interface designed to capture a measurement variable of the vehicle and designed to generate raw measurement data describing the measurement variable;
a processing means which is designed to process the raw measurement data to form measurement data.

Preferably, the sensor is protected against unauthorized access, in particular structurally.

Preferably, the sensor has at least one, in particular structural, protective measure against unauthorized access.

Preferably, at least one partial area or the entire sensor is structurally shielded from, in particular unauthorized, wireless access. For this purpose, at least the partial area or the entire sensor has shielding against wireless access as a structural protective measure. Wireless access can be understood as meaning inductive, capacitive and/or optical access. It is advantageous if corresponding shielding is provided, and the electromagnetic fields which are formed by electrical currents within the sensor are shielded to the outside, such that sensor-internal data cannot be accessed from the outside. It is also advantageous if the shielding prevents access via electromagnetic fields from the outside. This excludes unauthorized access to sensor-internal data up to and including the manipulation thereof. Shielding from optical access may in particular affect the measurement interface which may be designed to optically capture the measurement variable. In this way, appropriate placement of shielding elements can prevent the capture of the measurement variable from being distorted by the effect of light or radiation. Appropriate shielding can also prevent damage to light-sensitive sensor components such as chips, semiconductors, resistors or diodes.

Preferably, the shielding of the partial area is realized by shielding elements provided within the housing of the sensor or in or on one or more walls of the housing. These can be produced from a special alloy that adequately shields electromagnetic fields. The shielding elements are preferably placed such that locations at which corresponding wireless coupling elements can be fitted are completely or at least partially and adequately shielded. If the housing is made of plastic, the shielding elements can be molded into the plastic material of the housing. If a shielding element is applied to a wall of the housing (inner or outer wall), this can be effected in particular by adhesive bonding or by plugging or by clamping. Alternatively, the housing of the sensor can consist of the shielding elements. This then allows for complete shielding on all sides. If shielding elements are provided within the housing, they can preferably form an encapsulation of the partial area, with the result that a housing is then particularly preferably present in the housing.

Alternatively or additionally, provision may be made for the shielding of the partial area to be realized by a multi-layer structure of the sensor and for the partial area to be shielded to be shielded by layers of further components of the sensor arranged above this partial area or by appropriately arranged shielding elements. In particular, provision may be made for the sensor in the housing to have a multi-layer PCB structure (Printed Circuit Board structure). Certain lines or elements to be shielded, such as communication lines or debug lines, can be shielded by other elements printed or arranged above them and insulated from them, such as power supply lines.

It is also possible to provide a layer structure formed by a plurality of printed circuit boards. In this case, printed circuit boards to be shielded can be placed in such a way that they are covered by other printed circuit boards relative to the nearest housing walls. In addition, shielding elements, preferably in plate form, can also be introduced into the layer structure.

Preferably, the sensor, in particular as a structural protective measure, is designed to deactivate itself when the housing is opened without authorization. This can be effected non-destructively, with the result that the sensor can be reused when it is reactivated, for example by using one or more cryptographic keys provided for this purpose.

However, provision may also be made for the sensor to permanently deactivate itself by destroying itself. This can be effected, for example, by specifically overloading a circuit of the sensor. The opening of the housing can be detected by detection means, such as sensors, on the housing, which emit a signal as soon as the housing is opened. Provision may be made for opening of the housing to be permitted if the corresponding activation is received by the sensor via the data interface. This can be verified again by means of keys stored in the storage section. The detection means is preferably provided on the housing and is designed to detect the opening of the housing. The sensor may be designed such that a corresponding signal is output to the processing means or to another receiver outside the sensor, for example via its interface, by means of the detection means when the housing is open.

Preferably, the sensor is an angle sensor and the measurement variable captured via the measurement interface is a measurement variable describing a rotational movement of a rotatably provided element. The rotatably provided element can be in particular a steering column or an element of a vehicle steering system, from whose rotational movement a steering angle can be determined. In this case, the sensor is in the form of a steering angle sensor.

Preferably, the sensor is a rotation rate sensor. Preferably, the measurement variable captured via the measurement interface is a yaw rate of a vehicle, in which the sensor is provided. In this case, the sensor is in the form of a yaw rate sensor. Alternatively or additionally, provision may also be made for the measurement variable captured via the measurement interface to be a pitch rate and/or a roll rate of the vehicle.

Preferably, the sensor is an acceleration sensor, wherein the measurement variable captured via the measurement interface is an acceleration of a vehicle, in which the sensor is provided. The acceleration sensor can have a single-axis or multi-axis design, such that it can capture an acceleration in only one axial direction (longitudinal, transverse or vertical axis of the vehicle) or in a plurality of or all three axial directions.

Preferably, the sensor is formed as a combination of a rotation rate sensor described above and an acceleration sensor described above. In particular, the sensor may be designed to capture both the yaw, pitch and roll rate as well as the accelerations in all three axial directions.

Preferably, the sensor is a pressure sensor, wherein the measurement variable captured via the measurement interface is a pressure. In particular, the sensor can be a brake pressure sensor. This makes it possible to reliably capture a brake pressure in the case of fluidically actuated brakes such as pneumatic or hydraulic brakes.

Preferably, the sensor is a force sensor, wherein the measurement variable captured via the measurement interface is a force. In particular, the sensor can be a brake force sensor. This makes it possible to reliably capture a brake force in the case of fluidically actuated brakes such as pneumatic or hydraulic brakes or in the case of electromechanically actuated brakes. In particular, the force captured can be a tensioning force of a friction brake.

Preferably, the sensor is a speed sensor, wherein the measurement variable captured via the measurement interface is a speed. This can be a wheel speed or an engine speed. In particular, it may be an active speed sensor.

Preferably, the sensor is a position sensor, wherein the measurement variable captured via the measurement interface is in particular a position of a movable element. The movable element is, for example, a shifting element of a transmission or an actuating element for actuating a clutch. This makes it possible to reliably capture a shift position in a transmission or a clutch position.

Preferably, the sensor is a level sensor, wherein the measurement variable captured via the measurement interface is a level of a vehicle body of a vehicle, in which the sensor is provided. This makes it possible to improve the safety of the level control of such a vehicle.

Preferably, the sensor is an oil level sensor, wherein the measurement variable captured via the measurement interface is an oil level. This can be an oil level of an electrically driven compressor.

Preferably, the sensor is designed to detect whether an unauthorized data connection to the sensor has been or is being established. This can be verified by appropriately using a cryptographic key from the storage section or by a hash value generated by the processing means or a cryptographic signature. The sensor is preferably designed to deactivate itself or to put itself into a secure state or to interrupt the data connection when an unauthorized data connection is detected. The data connection can be CAN-based.

A system, in particular an open-loop control system, a closed-loop control system or a monitoring system for a vehicle, in particular for a commercial vehicle, having a sensor as described above is disclosed. The system is designed to determine whether the sensor is approved for use in the system by comparing at least one cryptographic key of the sensor with at least one cryptographic key of the system.

Preferably, the system is further designed to deactivate the sensor, to output a message or to deactivate the system or to transfer it to a secure state when a non-approved sensor is detected by the system.

This prevents a sensor not approved for the system from being used in the system.

The system is preferably in the form of an open-loop steering control system, for example with the sensor in the form of an angle sensor. It may alternatively be in the form of a closed-loop driving dynamics control system, for example with the sensor in the form of an angle sensor, a rotation rate sensor, an acceleration sensor, a pressure sensor, a force sensor and/or a speed sensor. It may alternatively be in the form of a closed-loop level control system, for example with the sensor in the form of a level sensor.

A vehicle, in particular a commercial vehicle, having a sensor as described above or having a system as described above is disclosed.

A method for checking the permissibility of a combination of a system, in particular an open-loop control system, a closed-loop control system or a monitoring system, for a vehicle having a sensor as described above is disclosed, wherein the method comprises the following steps:
providing the system, in particular a system described above, wherein the system has cryptographic keys;
providing the sensor as described above;
comparing at least one cryptographic key of the sensor with at least one cryptographic key of the system;
enabling the system with the sensor if the comparison determines that the sensor is approved for the system.

This makes it possible to determine whether a sensor approved for the system is already being used during assembly, during which the system and the sensor are assembled for the first time. Such a check can also be carried out later if the sensor is replaced due to maintenance or repair work.

The invention is described in more detail below with reference to the accompanying drawings.

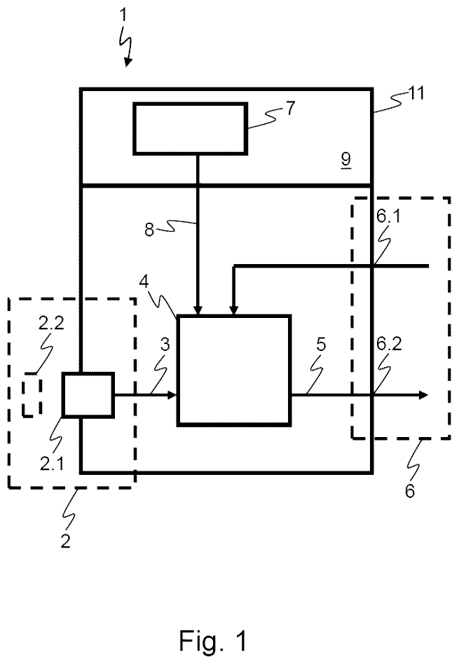

FIG. 1 shows a sensor according to a first embodiment.

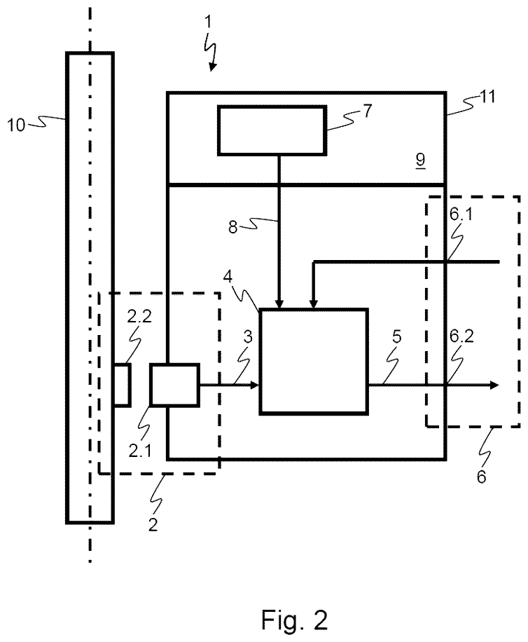

FIG. 2 shows a sensor according to a second embodiment.

FIG. 1 shows a sensor 1 according to a first embodiment.

A sensor 1 for a vehicle is shown. The sensor 1 has the following elements:
a housing 11;
a measurement interface 2 designed to capture a measurement variable of the vehicle and designed to generate raw measurement data 3 describing the measurement variable;
a processing means 4 which is designed to process the raw measurement data 3 to form measurement data 5;
a data interface 6 which is designed to exchange data between the sensor 1 and other transmitters or receivers and is connected to the processing means 4 for this exchange of data;
a storage section 7 which is designed to store at least one cryptographic key and to make it available exclusively to the processing means 4, wherein
the processing means 4 is designed to use the at least one key to encrypt, decrypt or validate data sent or received via the data interface 6, wherein
the storage section 7 is formed as or in a hardware security module.

The key can be sent to the processing means 4 via a data connection 8 shown.

The measurement interface 2 has a capture means 2.1 which is designed to capture the raw measurement data 3. The capture means 2.1 may be designed in particular to capture an acceleration, a rotation rate, a pressure, a force or an oil level. If a corresponding counterpart 2.2 is present and can carry out, for example, a relative movement (a rotational movement or translational movement) with respect to the capture means 2.1, the capture means 2.1 can be designed to capture a rotational movement or an angle, or a displacement, such as in the event of a level change or when capturing a position of a moving element.

FIG. 2 shows a sensor 1 according to a second embodiment.

A sensor 1, in particular for capturing a steering angle of a vehicle, is shown. The sensor 1 has the following elements:
a housing 11;
a measurement interface 2 designed to capture a rotational movement of a rotatably provided element 10 of the vehicle and designed to generate raw measurement data 3 describing the rotational movement;
a processing means 4 which is designed to process the raw measurement data 3 to form measurement data 5.

The rotatably provided element 10 is in the form of a steering column of a vehicle here. This is provided so as to be rotatable about the vertical dash-dotted axis.

The measurement interface 2 has a capture means 2.1 and a counterpart 2.2, wherein the counterpart 2.2 is connected to the element 10 and also carries out the rotational movement. This is captured by the capture means 2.1 and passed on as raw measurement data 3 to the processing means 4. The measurement interface 2 is shown here only by way of example. Other designs may also be provided. For example, the measurement interface 2 may have a ring element which is arranged coaxially and in a rotationally fixed manner with respect to the axis of the element 10, wherein its rotational movement is detected by the capture means 2.1.

Furthermore, the sensor 1 has the following elements:
a data interface 6 which is designed to exchange data between the sensor 1 and other transmitters or receivers and is connected to the processing means 4 for this exchange of data;
a storage section 7 which is designed to store at least one cryptographic key and to make it available exclusively to the processing means 4, wherein
the processing means 4 is designed to use this at least one key to encrypt, decrypt or validate data sent or received via the data interface 6, wherein
the storage section 7 is formed as or in a hardware security module.

The following description applies both to the embodiments shown in FIG. 1 and to the embodiments shown in FIG. 2.

The storage section 7 is provided here separately from the processing means 4 in a partial area 9 that has shielding (not shown) against wireless access as described above.

The data interface 6 has a receiving section 6.1 that can be used to send application data or program code to the sensor 1, such that in particular the processing means 4 can be updated and maintained.

The data interface 6 has a measurement data section 6.2 that can be used to send the measurement data 5 and status information relating to the sensor 1.

The storage section 7 makes it possible to securely store the at least one cryptographic key, and it is additionally shielded against wireless access from the outside in the partial area 9 of the housing 11. This partial area may have correspondingly formed alloys in or on the walls of the housing 11.

According to a further embodiment that is not shown, the processing means 4 is provided partially, preferably completely, in the partial area 9 of the housing 11 in order to protect essential functions of the sensor 1 which are realized by the processing means 4.

The sensors shown in FIGS. 1 and 2 may be designed, as a protective measure against unauthorized access, in such a way that they deactivate themselves as described above when the housing 11 is opened without authorization. This can be effected non-destructively, with the result that the sensor 1 can be reused when it is reactivated, for example by using one or more cryptographic keys provided for this purpose. However, provision may also be made for the sensor 1 to permanently deactivate itself by destroying itself. This can be effected, for example, by specifically overloading a circuit of the sensor 1.

### LIST OF REFERENCE SIGNS

1 Sensor
2 Measurement interface
2.1 Capture means
2.2 Counterpart
3 Raw measurement data
4 Processing means
5 Measurement data
6 Data interface
6.1 Receiving section
6.2 Measurement data section
7 Storage section
8 Data connection
9 Partial area
10 Rotatably provided element
11 Housing

1. A sensor for a vehicle, comprising:
a housing;
a measurement interface configured to capture a measurement variable of the vehicle and designed to generate raw measurement data describing the measurement variable;
a processing means which is configured to process the raw measurement data to form measurement data;
a data interface which is configured to exchange data between the sensor and other transmitters or receivers and is connected to the processing means for this exchange of data;
a storage section which is configured to store at least one cryptographic key and to make it available exclusively to the processing means, wherein
the processing means is configured to use the at least one key to encrypt, decrypt or validate data sent or received via the data interface, wherein
the storage section is formed as or in a hardware security module.

2. The sensor according to claim 1, wherein
the storage section is configured as a storage device structurally separated from the processing means.

3. The sensor according to claim 1, wherein
the storage section and the processing means are formed as a structural unit.

4. The sensor according to claim 1, wherein
the data received via the data interface are or include application data or program code.

5. The sensor according to claim 1, wherein
the data sent via the data interface are or contain the measurement data or status information relating to the sensor.

6. The sensor according to claim 1, wherein
the at least one key is linked to an identification mark of the sensor and/or to a manufacturer-specific identification mark and/or to a customer-specific identification mark, wherein
the identification mark of the sensor is preferably a part and/or serial number and/or a vehicle identification number and/or an ECU ID and/or a manufacturer name.

7. The sensor according to claim 1, wherein
the storage section is designed configured to store program parts of the processing means and/or the raw measurement data and/or the measurement data, which have been authorized by means of the at least one key, in the storage section.

8. The sensor according to claim 1, wherein
the sensor, in particular the processing means, is configured to check data, which in turn are provided with a cryptographic key and are received via the interface, or communication, which is directed to the sensor and is received via the interface, for the trustworthiness of its/their transmitter, wherein the sensor is further preferably configured to output a message via the interface or to deactivate itself or a system in which the sensor is provided, or to put itself into a secure state, if the transmission source or the received data or the communication directed to the sensor has/have been classified as untrustworthy.

9. The sensor according to claim 1, wherein
at least one partial area or the entire sensor has shielding against wireless access as a structural protective measure.

10. The sensor according to claim 9, wherein
the shielding of the partial area is realized by shielding elements provided within the housing of the sensor or in or on one or more walls of the housing, or wherein
the housing of the sensor consists of the shielding elements.

11. The sensor according to claim 9, wherein
the shielding of the partial area is realized by a multi-layer structure of the sensor and the partial area to be shielded is shielded by layers of further components of the sensor arranged above this partial area or by appropriately arranged shielding elements.

12. The sensor according to claim 1,
wherein the sensor is configured to deactivate itself when the housing is opened without authorization.

13. The sensor according to claim 1, wherein
the sensor is designed, as a protective measure, to detect whether an unauthorized data connection to the sensor has been or is being established.

14. The sensor according to claim 1, wherein
the sensor is an angle sensor and the measurement variable captured via the measurement interface is a measurement variable which describes a rotational movement of a rotatably provided element, wherein the rotatably provided element is in particular a steering column or an element of a vehicle steering system, from whose rotational movement a steering angle can be determined, or wherein
the sensor is a rotation rate sensor, wherein the measurement variable captured via the measurement interface is in particular a yaw, pitch and/or roll rate of a vehicle, in which the sensor is provided, or wherein
the sensor is an acceleration sensor, wherein the measurement variable captured via the measurement interface is an acceleration, or wherein
the sensor is a pressure sensor, wherein the measurement variable captured via the measurement interface is a pressure, or wherein
the sensor is a force sensor, wherein the measurement variable captured via the measurement interface is a force, or wherein
the sensor is a speed sensor, wherein the measurement variable captured via the measurement interface is a speed, or wherein
the sensor is a position sensor, wherein the measurement variable captured via the measurement interface is in particular a position of a movable element, or wherein
the sensor is a level sensor, wherein the measurement variable captured via the measurement interface is a level of a vehicle body of a vehicle, in which the sensor is provided, or wherein
the sensor is an oil level sensor, wherein the measurement variable captured via the measurement interface is an oil level.

15. A system, for a vehicle, comprising the sensor according to claim 1,
wherein the system is configured to determine whether the sensor is approved for use in the system by comparing at least one cryptographic key of the sensor with at least one cryptographic key of the system, and wherein the system is configured to deactivate the sensor, to output a message or to deactivate the system, or to transfer it to a secure state when a non-approved sensor is detected by the system.

16. A vehicle, comprising the sensor according to claim 1.

17. A method for checking permissibility of a combination of a system for a vehicle with a sensor, wherein the method comprises:
providing the system according to claim 15, wherein the system has cryptographic keys;
providing the sensor;
comparing at least one cryptographic key of the sensor with at least one cryptographic key of the system;
enabling the system with the sensor if the comparison determines that the sensor is approved for the system.
